(19) United States
(12) Patent Application Publication
(10) Pub. No.: US 2003/0129897 A1
(43) Pub. Date: Jul. 10, 2003

(54) Forming panel barrier

(76) Inventors: Howell B. Eleazer, Moore, SC (US); Allan M. Smith, Roebuck, SC (US); Thomas E. Godfrey, Moore, SC (US); William S. Freeman, Spartanburg, SC (US)

Correspondence Address: Jeffery E. Bacon, Milliken & Company, Legal Department, M-495, PO Box 1926, Spartanburg, SC, 29304, US

(21) Appl. No.: 10/273,396

(22) Filed: Oct. 17, 2002

Related U.S. Application Data
(63) Continuation of application No. 09/652,731, filed on Aug. 31, 2000, now abandoned.

(51) Int. Cl. B32B 5/02; B32B 27/04; B32B 27/12; B32B 9/04; B32B 27/34; B32B 27/02; B32B 23/02; D03D 15/00; B32B 5/08; B32B 5/26; B32B 21/10; B32B 25/02; B32B 25/10; B32B 29/02; B32B 27/00; B32B 27/40; B32B 15/04; B32B 19/04; B32B 23/04

(52) U.S. Cl. 442/66; 442/64; 442/152; 442/153; 442/158; 442/149; 442/164; 442/165; 442/217; 442/218; 442/255; 442/257; 442/259; 442/260; 442/261; 428/423.5; 428/423.9; 428/425.1; 428/444; 428/445

(57) ABSTRACT

A forming panel having board with a release barrier of a substrate and a barrier/release layer secured to the board by an adhesive.

### BACKGROUND

The present invention relates generally to forming panels, and in particular, to barrier surfaces for forming panels.

Forming panels are used for the formation of materials such as concrete or cement. Forming panels need an interior surface that is a barrier to the material being formed and will release from the material once the forming process is completed. Additionally, the interior surface must resist corrosion from the material being formed and present a desired surface for the material being formed. Therefore, there is a need for forming panels and barrier surfaces of forming panels that satisfies these needs.

### BRIEF DESCRIPTION OF THE DRAWINGS

FIG. 1 is a cross sectional view of an embodiment of the present invention illustrated as a forming panel having a board with a substrate attached to the board by an adhesive, and a barrier/release layer on the external surface of the substrate.

### DETAILED DESCRIPTION

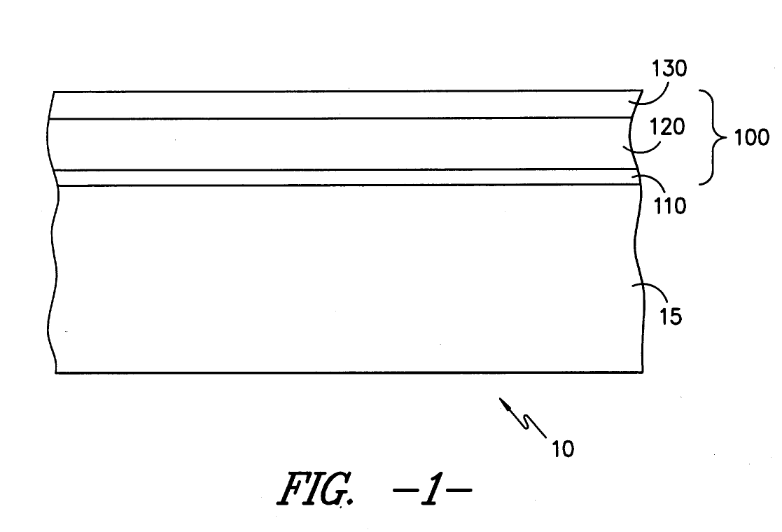

Referring now to FIG. 1, there is shown a cross sectional embodiment of the present invention illustrated at the forming panel 10. The forming panel 10 generally comprises a board 15, and a release barrier 100. The release barrier 100 includes a substrate 120 and a barrier/release layer 130. An adhesive coating 110 adheres to the side of the substrate 120 opposite of the barrier/release material 130 to a surface of the board 15.

The board 15 of the forming panel 10 is structured for the load experienced by the forming panel 10 during the forming process of a material such as concrete. The board 15 is typically an engineered lumber such as plywood, composite, oriented strand board, or the like. However, the board 15 can be formed of suitable material other than wood, such as plastic, metal, fiberglass, of any other similar structural material. The exterior surface of the board 15 is finished with the appropriate smoothness used in the application. The smooth of the finish of the board 15, the higher the cost of forming the board 15 and the lower the cost of the release barrier 100 in compensating for finish irregularities. The rougher the finish of the outer surface of the board 15, the lower the cost of the board 15 and the higher the cost of the release barrier 100 in compensating for the roughness of the outer surface of the board 15. Many boards 15 will include an exterior veneer for controlling the surface finish and providing structural resistance on the exterior. An example of an exterior surface would be a hardwood veneer.

The adhesive 110 is typically a thermoplastic adhesive such as a polyamide adhesive. However, other thermoplastic adhesives are suitable such as polyethylene, polyolefin, polyester, or the like. Other adhesives, such as phenolic formaldehyde, unsaturated polyester resins, metalecene catalyzed polyethylene, or the like can be used as the adhesive 110. Additionally, the adhesive 110 can be a ionomer resin, an acid copolymer resin, or polyester resin material. The adhesive 110 phase is preferably a low viscosity material during the application for flowing into the surface of the board 15 and the substrate 120. In one embodiment, the release barrier 100 is adhered to the board 15 in a pressing process of between 280° and 310° F. at 200 psi. Adhesives using this process become molten below this temperature and pressure. The adhesive 10 can be considered a portion of the release barrier 100, or a separate coating that is applied to the board 15 prior to securing the release barrier 100 to the board 15.

The substrate 120 can be formed of textiles, such as wovens, nonwovens, knits, or laid scrim, or other material such as paper, film, or the like. Textiles used for the substrate 120 can be formed of materials such as cotton, polyester, blends of cotton and polyester, polypropylene, nylon, or any other synthetic or natural fibers. In one embodiment of a substrate 120 formed of a woven material, the material being a blend of 65% polyester and 35% cotton. Generally, natural fibers, such as cotton, provide better bonds with the adhesive through chemical and mechanical processes. Also, synthetic fibers, such as polyester, provide a lower cost material with smoother surfaces. Additionally, characteristics can be given to synthetic fibers, such as polyester, through spinning, texturing, sanding, calendaring, or machine face finishing the material that assist in the bonding process.

Nonwoven materials used as the substrates 120 can be spun bond, or any other method of forming a nonwoven, and can be used with crimped or with straight fibers. By using crimped fibers or a nonwoven that has been needle punched, the tendency of the nonwoven layer to separate can be reduced. Additionally, nonwoven material can be formed with low melt blend fiber for improving the internal bond strength of the substrate 120, or assisting the adhesive 110 in bonding to the board 15.

In one embodiment where the substrate 120 is a knit material, a warp knit material is used as the substrate 120. The warp knit material assists in reducing costs and providing stability. Additionally, a warp knit material is more amenable to a coating process for the application of the adhesive 110 and/or the barrier/release layer 130.

In one embodiment where the substrate 120 is a laid scrim, the open nature of the laid scrim provides contact between the barrier/release layer 130 and the adhesive 110. Additionally, the laid scrim is typically a lower cost material. However, a laid scrim may reduce the ability of the substrate 120 to provide a leveling function on the surface of the board 15.

In an embodiment where the substrate 120 is a paper, paper such as craft paper can be used. Additionally, the paper can be impregnated with a material such as a phenolic resin, which can also serve as the adhesive 110. This same function can be served by an unsaturated polyester resin.

The substrate 120 provides a carrier for the barrier/release layer 130 and/or the adhesive 110. Additionally, the substrate 120 assists in masking the wood grain to the outside surface of the forming panel where the barrier/release layer 130 is applied. It is believed that the substrate 120 assists in the adhesive process in bonding the release barrier 100 to the board 15. Additionally, the substrate 120 assists in the impact strength of the forming panel 10 to help prevent dings or surface irregularities due to impacts.

The interaces within the substrate 120 provide an open space for the adhesive 110 and the barrier/release layer 130 to form a mechanical bond. The fiber or yarns of the substrate 120 can also assist in the bonding process by the texture, hairiness, or fibrils, and the cleanliness of the material. Generally, the courser the yarn the rougher the surface of the substrate 120, and the finer the yarn the smoother the surface of the substrate 120. Additionally, the material of the substrate 120 is selected to minimize shrinkage in the forming process to reduce the impact on adhesion.

The barrier/release layer 130 provides chemical resistance (particularly to alkalinity), moisture barrier properties, abrasion resistance, and a release surface. Additionally, the barrier/release layer 130 provides a UV resistant coating to the substrate 120, adhesive 110, and board 15. The barrier/release layer 130 is selected to provide bond strength to the substrate (through chemical and/or mechanical means), abrasion resistance, machineability (particularly cuttability without fracturing), and face checking.

The barrier/release layer 130 contributes the abrasion resistance of the release barrier 100 and the forming panel 10. Abrasion resistance is defined herein as experiencing about 0.01 inch depth abrasions or less in a Tabor Abraser equipped CS-17 Calibrase wheels with 1000 grams thereon and cycled for a total of 10,000 rotations. In a preferred embodiment, the forming panel 10 with the release barrier 100 would have at least this level of abrasion resistance.

The barrier/release layer 130 also contributes to the face checking resistance of the release barrier 100. In one embodiment, the face checking of a forming panel 10 with the release barrier 100, face checking is reduced to less than 40 mm.

The barrier/release layer 130 can be formed of a material placed onto, or into, the substrate 120. Materials for the barrier/release layer 130 include materials such as polymeric thermoset materials, and thermoplastic materials such as nylon or polypropylene. Additionally, other materials such as epoxy, silicone, latex, urethane, cross-link acrylic, or the like, can be used as the barrier/release layer. The barrier/release material 130 can be filled with materials such as colorant, talc, aluminum, nanomer particles, titanium oxide, calcium carbonate, glass, and blooming agents with release material. Particle fillers will provide a harder surface for the barrier/release layer 130. A blooming agent with release material in the barrier/release material 130 will allow a continuous small amount of release material to migrate to the surface of the barrier/release material 130 adjacent to the material being formed.

It is the barrier/release layer 130 that provides the forming panel 10 with a majority of its alkalinity resistance attributes. In one embodiment, the barrier/release layer 130 is alkaline invert, which is defined herein as having no visually detectable degradation after being exposed to a 5% solution of sodium hydroxide for a period of 72 hours.

The selection of the adhesive 110, the substrate 120, and the barrier/release layer 130, provide properties which assist in masking or leveling the imperfections on the board 15 due to grain and/or other imperfections. Additionally, the selection of the adhesive 110, the substrate 120, and the barrier/release layer 130 also provide attributes to the release barrier 100 that inhibit face checking. Furthermore, the adhesive 110 and barrier 130 can be selected for compatibility in situations where the substrate 120 allows the two components to contact, or in situations where the substrate 120 does not exist.

The release barrier 100 is generally form by extrusion coating the barrier/release material 130 onto to the substrate 120. For embodiment of the release barrier 100 having the adhesive 110 thereon, the adhesive 110 is extruded onto the opposite side of the substrate 120 from the barrier/release layer 130. After the release barrier 100 is coated with the barrier/release layer 130, and the adhesive 110 (when appropriate), the release barrier 100 is rolled into a roll for application at a later time onto the board 15.

In one method of forming the forming panel 10, components of the board 15 are stacked into a mold and the release barrier 100, having the adhesive 110 thereon, is placed on top of the components of the board 15 with the adhesive 110 facing the components. The stack is subjected to heat and pressure over sufficient time to bond the components of the board 15 together with the release barrier 100 thereon. In an embodiment of the present invention where the adhesive 110 is not integral with the release barrier 100, the adhesive 110 is applied to the top component of the board 15 after the components of the board 15 are stacked and prior to the positioning of the release barrier 100 thereon, and then the total components, including the release barrier 100, are subject to the heat and pressure for forming the forming panel 10.

In another embodiment, the components of the board 15 are stacked in a mold and are subjected to heat and pressure to form the board 15. A face of the board 15 is sanded and smoothed after the stacked board components are unified. After the face of the board 15 is smooth, the release barrier 100 is applied to the smooth surface and the board 15 with the release barrier 100 thereon is subjected to heat and pressure over sufficient time to bond the two components together.

The present invention can be further explained with reference to the following examples:

### EXAMPLE 1

A release barrier was formed with a substrate of a woven material having warp yarns being 23/1 cotton count of 100% KP Cotton and having fill yarns being 23/1 cotton count of 100% KP. Cotton. The substrate was coated with a barrier/release layer of polyamide 4 mils. thick.

### EXAMPLE 2

A release barrier was formed with the substrate and barrier release layer according to Example 1, and included an adhesive of 4 mils metallocene catalyzed polyethylene on the substrate opposite to the barrier/release layer.

### EXAMPLE 3

A forming panel was formed with a substrate according to Examples 1 and 2 adhered to a board by an adhesive according to Example 2, and a barrier/release layer according to Examples 1 and 2 on side of the substrate opposite to the board.

### EXAMPLE 4

A release barrier was formed with a substrate of a woven material having warp yarns being 15/1 cotton count of a blend of 65% polyester and 35% cotton and having fill yarns being 23/1 cotton count of a blend of 65% polyester and 35% cotton. The substrate was coated with a barrier/release layer of polyamide 4 mils. thick.

### EXAMPLE 5

A release barrier was formed with the substrate and barrier release layer according to Example 4, and included an adhesive of 4 mils metallocene catalyzed polyethylene on the substrate opposite to the barrier/release layer.

### EXAMPLE 6

A forming panel was formed with a substrate according to Examples 4 and 5 adhered to a board by an adhesive according to Example 5, and a barrier/release layer according to Examples 4 and 5 on side of the substrate opposite to the board.

### EXAMPLE 7

A release barrier was formed with a substrate of a woven material having warp yarns being 1/150/34, textured, 100% polyethylene and having fill yarns being 1/150/34, textured, 100% polyethylene. The substrate was coated with a barrier/release layer of polyamide 4 mils. thick.

### EXAMPLE 8

A release barrier was formed with the substrate and barrier release layer according to Example 7, and included an adhesive of 4 mils metallocene catalyzed polyethylene on the substrate opposite to the barrier/release layer.

### EXAMPLE 9

A forming panel was formed with a substrate according to Examples 7 and 8 adhered to a board by an adhesive according to Example 8, and a barrier/release layer according to Examples 7 and 8 on side of the substrate opposite to the board.

What is claimed is:

1. A forming panel comprising:
a board having a forming surface;
a substrate;
an adhesive securing the substrate to the forming surface of the board; and
a barrier/release layer secured to the substrate opposite of the board, the barrier/release layer being alkaline impervious;
and wherein the barrier/release layer secured the board via the substrate and the adhesive is abrasion resistant.

2. The forming panel according to claim 1, wherein the barrier/release layer comprises a polyamide.

3. The forming panel according to claim 2, wherein the polyamide of the barrier/release layer is about 4 mils. thick.

4. The forming panel according to claim 1, wherein the substrate comprises a woven material.

5. The forming panel according to claim 4, wherein the woven material of the substrate comprises warp and fill yarns of cotton.

6. The forming panel according to claim 4, wherein the woven material of the substrate comprises warp and fill yarns of polyester.

7. The forming panel according to claim 4, wherein the woven material of the substrate comprises warp and fill yarns of a blend of about 35% cotton and about 65% polyester.

8. The forming panel according to claim 1, wherein the adhesive comprises a layer of metallocene catalyzed polyethylene.

9. The forming panel according to claim 8, wherein the layer of polyethylene of the adhesive is about 4 mils. thick.

10. The forming panel according to claim 1, wherein the board comprises wood.

11. The forming panel according to claim 1, wherein the board comprises plastic.

12. The forming panel according to claim 1, wherein the board comprises metal.

13. The forming panel according to claim 1, wherein the board comprises fiberglass.

14. The forming panel according to claim 1, wherein the substrate comprises a nonwoven material.

15. The forming panel according to claim 1, wherein the substrate comprises a knitted material.

16. The forming panel according to claim 1, wherein the substrate comprises a laid scrim material.

17. The forming panel according to claim 1, wherein the substrate comprises a paper material.

18. The forming panel according to claim 1, wherein the barrier/release layer comprises a thermoplastic.

19. The forming panel according to claim 1, wherein the barrier/release layer comprises a thermoset plastic.

20. The forming panel according to claim 1, wherein the barrier/release layer comprises an epoxy.

21. The forming panel according to claim 1, wherein the barrier/release layer comprises a silicone material.

22. The forming panel according to claim 1, wherein the barrier/release layer comprises a latex material.

23. The forming panel according to claim 1, wherein the barrier/release layer comprises a urethane material.

24. The forming panel according to claim 1, wherein the barrier/release layer comprises an acrylic material.

25. The forming panel according to claim 1, wherein the barrier/release layer further includes a filler.

26. The forming panel according to claim 25, wherein the filler of the barrier/release layer comprises a colorant.

28. The forming panel according to claim 25, wherein the filler of the barrier/release layer comprises a talc.

29. The forming panel according to claim 25, wherein the filler of the barrier/release layer comprises aluminum.

30. The forming panel according to claim 25, wherein the filler of the barrier/release layer comprises titanium dioxide.

31. The forming panel according to claim 25, wherein the filler of the barrier/release layer comprises nanomer particles.

32. The forming panel according to claim 25, wherein the filler of the barrier/release layer comprises calcium carbonate.

33. The forming panel according to claim 25, wherein the filler of the barrier/release layer comprises glass.

34. The forming panel according to claim 25, wherein the filler of the barrier/release layer comprises a blooming agents of a release material.
